(19) United States
(12) Patent Application Publication
(10) Pub. No.: US 2009/0248761 A1
(43) Pub. Date: Oct. 1, 2009

(54) FILE CONTROL SYSTEM, INFORMATION PROCESSING DEVICE, HOST DEVICE, AND RECORDING MEDIUM THAT STORES PROGRAM

(76) Inventor: TAKAHISA SHIRAKAWA, Tokyo (JP)

Correspondence Address: NEC CORPORATION OF AMERICA, 6535 N. STATE HWY 161, IRVING, TX, 75039, US

(21) Appl. No.: 12/410,627

(22) Filed: Mar. 25, 2009

(30) Foreign Application Priority Data
Mar. 28, 2008 (JP) P2008-086450

(51) Int. Cl. G06F 12/16; G06F 12/00; G06F 17/30

(52) U.S. Cl. 707/204; 707/201; 707/E17.01; 707/E17.044; 711/E12.001; 711/E12.103

(57) ABSTRACT

A file control system according to the present invention includes a host device and an information processing device that is connectable to the host device via a network, the host device including: a comparator that compares first file information stored in a first storage unit of the information processing device with second file information stored in a second storage unit of the host device, and extracts differential information; and a transmitter that transmits the differential information to the information processing device, and the information processing device including: a receiver that receives the differential information; and a generator that generates index information on a file that is stored in the second storage unit and not stored in the first storage unit based on the received differential information.

This application is based upon and claims the benefit of priority from Japanese patent application No. 2008-086450, filed on Mar. 28, 2008, the disclosure of which is incorporated herein in its entirely by reference.

### BACKGROUND OF THE INVENTION

1. Field of the Invention

The present invention relates to a system, a device and a recording medium that stores a program that back up a file of a client to a network storage.

2. Description of Related Art

Conventionally, information processing devices such as personal computers include an internal HDD (hard disk drive), in which data can be stored and managed. However, there are limitations on the capacity of storage units provided in terminals intended for portable use. If the HDD gets damaged and breaks down, or reaches the end of its service life, there is a danger that the data stored in it will be lost. Therefore, by using, for example, a network server, the data is stored via the network in a host device having another storage unit. However, in backup processing performed in homes or such like, data must be backed up by user manipulation. Even when using special software to back up the data, backup commands must be issued after setting up the software, which is troublesome. To reduce such troublesome operations, Japanese Unexamined Patent Application, First Publication No. H9-319639 proposes technology for automatically backing up a server side with files accumulated in an internal storage device on a client side, without burdening the user.

There are cases where a backed-up file is not left in the client-side storage device, for reasons such as insufficient storage capacity of that storage device. In such cases, even if a file that was backed up on the server side is needed again on the client side, after a certain period of time has elapsed, the user often does not remember the name of the file, and it is difficult for him to search for it.

### SUMMARY OF THE INVENTION

It is an object of the present invention to enable a file, which was backed up from a client-side storage device to the server side and is not left in the client-side storage device, to be viewed as if it were stored in the client-side storage device, and to enable a user to easily re-access the backed-up file.

A file control system according to a first exemplary aspect of the present invention includes a host device and an information processing device that is connectable to the host device via a network, the host device including: a comparator that compares first file information stored in a first storage unit of the information processing device with second file information stored in a second storage unit of the host device, and extracts differential information; and a transmitter that transmits the differential information to the information processing device, and the information processing device including: a receiver that receives the differential information; and a generator that generates index information on a file that is stored in the second storage unit and not stored in the first storage unit based on the received differential information.

In the file control system according to the first exemplary aspect of the present invention, the information processing device may further include a display unit that displays file information in the index information in association with the first storage unit.

An information processing device according to a second exemplary aspect of the present invention constitutes a file control system including a host device and the information processing device that is connectable to the host device via a network, the host device including: a comparator that compares first file information stored in a first storage unit of the information processing device with second file information stored in a second storage unit of the host device, and extracts differential information; and a transmitter that transmits the differential information to the information processing device, and the information processing device including: a receiver that receives the differential information; and a generator that generates index information on a file that is stored in the second storage unit and not stored in the first storage unit based on the received differential information.

The information processing device according to the second exemplary aspect of the present invention may further include a display unit that displays file information in the index information in association with the first storage unit.

An information processing device according to a third exemplary aspect of the invention constitutes a file control system including a host device and the information processing device that is connectable to the host device via a network, the host device including: a first storage unit that stores a file from the information processing device; and a transmitter that sends the file to the information processing device, and the information processing device including: a second storage unit; a list of information on a file transmitted from the information processing device to the host device, the list being stored in the second storage unit; a file controller that reads file information stored in the second storage unit using an OS function of the information processing device; a comparator that compares the list and the file information read from the file controller; and a generator that generates index information on a file that is stored in the first storage unit and not stored in the second storage unit based on differential information obtained by the comparator.

The information processing device according to the third exemplary aspect of the present invention may further include a display unit that display file information based on the index information in association with the second storage unit.

An information processing device according to a fourth exemplary aspect of the present invention constitutes a file control system including a host device and the information processing device that is connectable to the host device via a network, the host device including: a first storage unit that stores a file from the information processing device; and a transmitter that sends the file stored in the first storage unit to the information processing device, and the information processing device including: a second storage unit; a list of information on a file transmitted from the information processing device to the host device, the list being stored in the second storage unit; a file controller that reads file information stored in the second storage unit using an OS function of the information processing device; a comparator that compares the list and the file information read from the file controller; a generator that generates index information on a file that is stored in the first storage unit and not stored in the second storage unit based on differential information obtained by the comparator; and a file controller that adds information of the list to a list of the file information stored in the second storage unit to expand the list of the file information as a list of logical file information of the second storage unit.

An information processing device according to a fifth exemplary aspect of the present invention constitutes a file control system including a host device and an information processing device that is connectable to the host device via a network, the host device including: a first storage unit that stores a file from the information processing device; and a transmitter that sends the file to the information processing device, and the information processing device including: a second storage unit; a list of file information transmitted from the information processing device to the host device, the list being stored in the second storage unit; a file controller that reads file information stored in the second storage unit using an OS function of the information processing device; a comparator that compares the list and the file information read from the file controller; a generator that generates index information on a file that is stored in the first storage unit and not stored in the second storage unit based on differential information obtained from the comparator; a display unit that displays file information based on the index information in association with the second storage unit; and a display converter that, before a display format of the file information of the list is inputted to the file controller, converts the display format to a display format that differs from that of a file in the first storage unit.

A host device according to a sixth exemplary aspect of the present invention constitutes a file control system including the host device and an information processing device that is connectable to the host device via a network, the host device including a comparator that compares first file information stored in a first storage unit of the information processing device with second file information stored in a second storage unit of the host device, and extracts differential information; and a transmitter that transmits the differential information to the information processing device, and the information processing device including a receiver that receives the differential information; and a generator that generates index information on a file that is stored in the second storage unit and not stored in the first storage unit based on the received differential information.

In the host device according to a seventh exemplary aspect of the present invention, the information processing device may further include a display unit that displays file information based on the index information in association with the first storage unit.

A recording medium according to an eighth exemplary aspect of the present invention stores a computer program executed by an information processing device that constitutes a system including a host device and an information processing device that is connectable to the host device via a network, the program including: comparing first file information stored in a first storage unit of the information processing device with second file information stored in a second storage unit of the host device, and extracting differential information; transmitting the differential information to the information processing device; receiving the differential information; and generating index information on a file that is stored in the second storage unit and not stored in the first storage unit based on the received differential information, comparing the first file information and transmitting the differential information being executed in the host device, and receiving the differential information and generating the index information being executed in the information processing device.

In the recording medium according to the eighth exemplary aspect of the present invention, the computer program may further include displaying file information based on the index information in association with the first storage unit, and displaying the file information is executed in the processing device.

A recording medium according to a ninth exemplary aspect of the present invention stores a computer program executed by an information processing device that constitutes a system including a host device and the information processing device that is connectable to the host device via a network, the program including: storing a file from the information processing device in a first storage unit of the host device; sending the file to the information processing device; storing a list of information on a file transmitted from the information processing device to the host device, the list being stored in a second storage unit of the information processing device; using an OS function of the information processing device to read the file information stored in the second storage unit; comparing the list and the file information read in using the OS function; and generating index information on a file that is stored in the first storage unit and not stored in the second storage unit based on differential information obtained by the comparator, storing the file and sending the file being executed in the host device, and storing the list, using the OS function, comparing the list and generating the index information being executed in the information processing device.

In the recording medium according to the ninth exemplary aspect of the present invention, the program may further include displaying file information based on the index information in association with the second storage unit, and displaying the file information is executed in the information processing device.

According to the invention, even when a file backed up from a client-side storage device to the server side is not left in the client-side storage unit, it can be viewed as if it were stored in the client-side storage unit, and can easily be re-accessed by the user.

### BRIEF DESCRIPTION OF THE DRAWINGS

FIG. 1 is an explanatory block diagram showing a system configuration according to a first exemplary embodiment of the invention.

FIG. 2 is an explanatory block diagram showing a system configuration according to a first exemplary embodiment of the invention.

FIG. 3A is a sequence chart showing an operation when logged on to a host device according to the first exemplary embodiment of the invention.

FIG. 3B is an explanatory diagram showing an image display when logged on to the host device according to the first exemplary embodiment of the invention.

FIG. 4A is an explanatory sequence chart showing an operation when logged off from the host device according to the first exemplary embodiment of the invention.

FIG. 4B is an explanatory diagram showing an image display when logged off from the host device according to the first exemplary embodiment of the invention.

FIG. 5A is an explanatory sequence chart showing an operation when logged on to a host device according to a second exemplary embodiment of the invention.

FIG. 5B is an explanatory diagram showing a screen display when logged off from the host device according to the second exemplary embodiment of the invention.

### DETAILED DESCRIPTION OF PREFERRED EMBODIMENTS

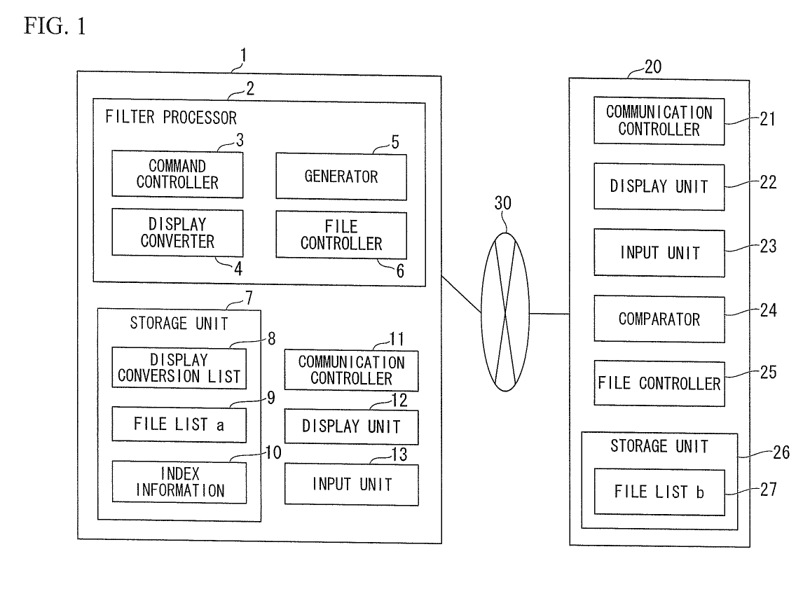

Exemplary embodiments for carrying out the invention will be explained with reference to the drawings. Firstly, an information processing device according to a first exemplary embodiment of the invention will be explained with reference to FIG. 1. FIG. 1 is an explanatory block diagram showing the configuration of a system according to the first exemplary embodiment including the information processing device 1, a network 30, and a host device 20. As shown in FIG. 1, the information processing device 1 includes a filter processor 2, a storage unit 7, a communication controller 11, a display unit 12, and an input unit 13.

The host device 20 includes a communication controller 21, a display unit 22, an input unit 23, a comparator 24, a file controller 25, and a storage unit 26.

The storage unit 26 stores a file list b 27. The information processing device 1 and the host device 20 can be connected via a network by using a network 30. The filter processor 2 of the information processing device 1 includes a command controller 3, a display converter 4, a generator 5, and a file controller 6. The storage unit 7 stores a display conversion list 8, a file list a (sequence diagram) 9, and index information 10.

The command controller 3 receives a command relating to access to a file generated by manipulation performed by a user who uses the information processing device 1, and determines processing.

The display converter 4 converts a method of displaying a file on the display unit 12 to a display format that accords with display rules defined by the display conversion list 8 stored in the storage unit 7. For example, the display converter 4 displays the file name in a different color than the other files, and updates the attribute of the file from, for example, “doc” to “doc_off”.

The comparator 24 of the host device 20 compares the file list b (sequence diagram) 27 stored in the storage unit 26 of the host device 20 with the file list a 9 stored in the storage unit 7, and extracts differential information of the file. The generator 5 receives the differential information of the file from the communication controller 11 via the communication controller 21. From the received file differential information, the generator 5 generates index information 10.

The communication controller 11 performs a process for connecting the information processing device 1 to the network 30.

Backup processors for backing up files stored in the storage unit 7 of the information processing device 1 can be mounted both in the information processing device 1 and in the storage unit 26 of the host device 20. When the command controller 3 of the filter processor 2 detects that a file has been newly stored in the storage unit 7 of the information processing device, or detects that a file has been updated, the file controller 6 performs a backup process of transmitting the file to the host device 20. The file controller 25 of the host device 20 secures a storage region corresponding to the information processing device 1 in the storage unit 26 of the host device 20, and stores the file there. The backed-up file can be deleted by a backup unit mounted in the information processing device 1, or kept in storage.

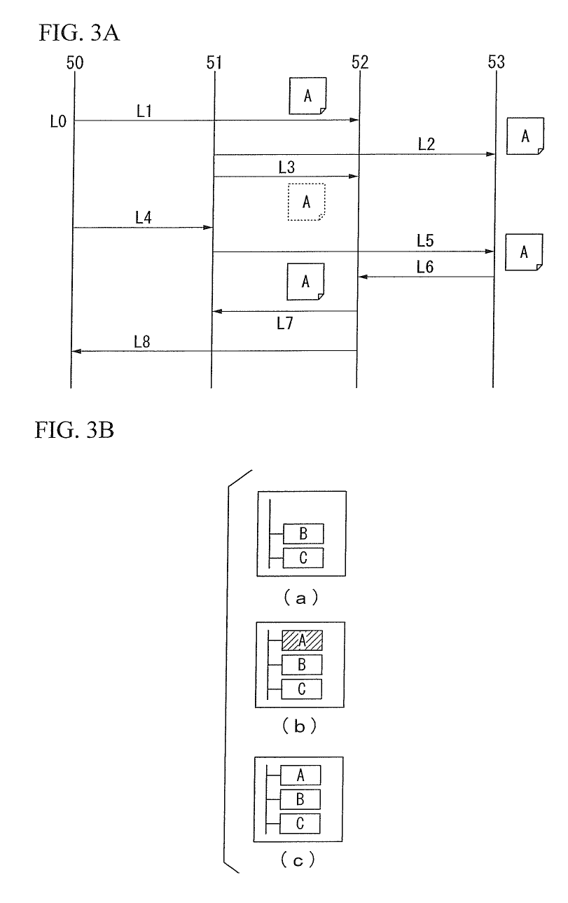

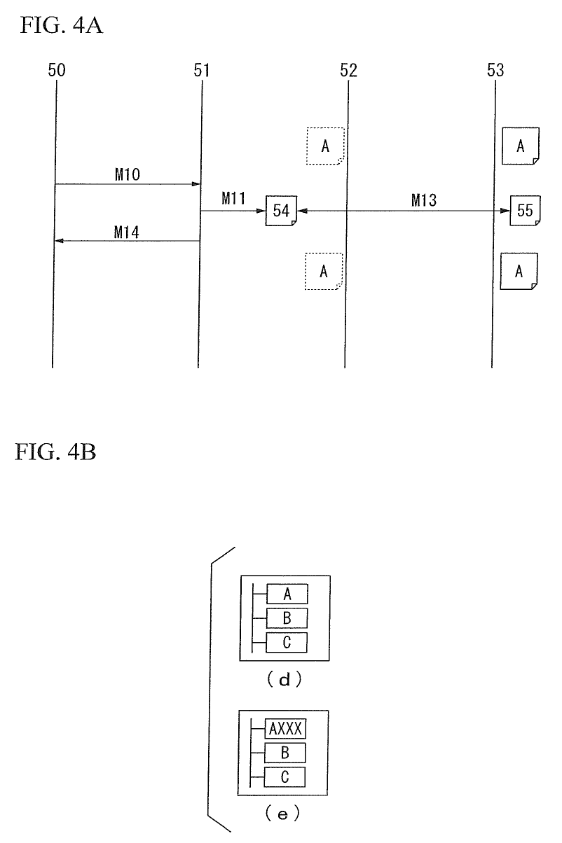

Subsequently, referring to FIGS. 3A, 3B, 4A, and 4B, an operation of the information processing device 1 according to the first exemplary embodiment of the invention will be explained.

FIG. 3 illustrates an AP (application) 50, a virtual filter control 51, an internal HDD 52, and a storage HDD 53. The AP 50 is an application that can process a file in the information processing device 1. The virtual filter control 51 performs control of temporarily intercepting a file access command of the AP 50 and performing a process in the interior of a filter, and eventually performing a process of returning the process to the AP 50. The internal HDD 52 is, for example, an internal hard disk corresponding to the storage unit 7 of the information processing device 1. The storage HDD 53 is the storage unit 26 in the host device 20, and can include a database function. In this example, the information processing device 1 is connected via the network 30 to the host device 20, and a user of the information processing device 1 to log on to the host device 20 so that it is possible to use the file backup service. In this state, following processes are performed between the information processing device 1 and the host device 20. When a file is written or updated to the internal HDD 52 of the information processing device 1, this file is backed up in the storage HDD 53, which is one example of the storage unit 26 of the host device 20. A setting is made by, for example, a program or the like installed in the information processing device 1 and the host device 20, so that the file is not left in the internal HDD 52 of the information processing device 1, but is moved to the storage HDD 53.

Firstly, the user manipulates the AP 50 to create a new file A (Newly create file A: step L0). When the user's manipulation of the AP 50 generates a process of writing file A to the internal HDD 52 (Write file A: step L1), the command controller 3 detects a file write command. The file controller 6 then stores file A in the internal HDD 52. File A is transmitted by the file controller 6 via the communication controller 11 to the network 30, and is backed up via the communication controller 11 of the host device 20 to the storage HDD 53, which is the storage unit 26 of the host device 20 (Back up file A: step L2). Since backed-up files are set to be deleted from the internal HDD 52 to minimize usage of the storage capacity of the internal HDD 52 of the information processing device 1, a command is issued to delete file A (Delete file A: step L3). The file controller 6 deletes file A, and file list a 9 is updated accordingly. The file controller 25 additionally stores file A in the storage HDD 53, which is one example of the storage unit 26. On the host device 20 side, file A is updated in file list b 27. Here, the comparator 24 transmits file differential information, obtained by comparing file list a 9 with file list b 27, via the communication controller 21, the network 30, and the communication controller 11 to the generator 5. The file differential information is, for example, information for ascertaining files which are not stored in the storage unit 7 but are stored in the storage unit 26. The generator 5 generates index information 10 from the file differential information, and stores it in the storage unit 7. The index information 10 contains, for example, detail information of files that are not stored in the storage unit 7 but are stored in the storage unit 26.

A screen display of the information processing device 1 will be explained. When a file is displayed using Windows™ Explorer or the like, as shown in part (a) of FIG. 3B, before writing file A, file A is not displayed on the screen of the display unit 12 of the information processing device 1. On the other hand, after file A has been stored in the internal HDD 52, it is displayed as shown in part (b) of FIG. 3B. Even when file A is deleted in step L3, the display converter 4 uses the index information 10 to display file A on the screen as shown in part (b) of FIG. 3B. In the storage unit 7, the display method is determined based on the display conversion list 8 stored in the storage unit 7. For example, when a file stored in the internal HDD 52 is removed from the internal HDD 52 while being backed up in the host device 20, if the information processing device 1 is online, that file is displayed in the same manner as other files. Even if a backed-up file is deleted from the internal HDD 52, it is displayed as if it was still in the folder at the time of the backup.

Moreover, when the user of the information processing device 1 clicks on file A with a mouse (Read file A: step L4), which does not exist in the internal HDD 52 but is being displayed on the screen of the display unit 12 as shown in part (b) of FIG. 3B, the command controller 3 detects a command relating to step L4. At this time, access to file A is momentarily interrupted. The command controller 3 reports detection of the command to the file controller 6, and the file controller 6 issues an instruction to rewrite file A from the host device 20 to the information processing device 1 (Instruction to rewrite file A: step L5). The file controller 25 of the host device 20 receives the instruction of step L5, and performs a process of transmitting the file A stored in the storage unit 26 back to the information processing device 1 and rewriting it in the internal HDD 52 (Process of rewriting file A: step L6). When a completion response is issued at the point where storage of file A in the internal HDD 52 is completed (File A rewrite completion response: step L7), interruption of the access to file A is cancelled and access to file A is reopened (File A read response: step L8). As shown in part (c) of FIG. 3B, the file A stored in the internal HDD 52 is then displayed by Explorer on the screen of the display unit 12.

Subsequently, a sequence containing logoff from a network storage service will be explained with reference to FIGS. 4A and 4B. In this example shown in FIG. 4A, a user of the information processing device 1 is switched from the log-on state in FIG. 3A in which lie logs on to the host device 20 to a logged-off state, or where the information processing device 1 is not accessing the host device 20 due to being disconnected from the network 30. In this example file A does not exist in the internal HDD 52 but is stored in the storage unit 26 of the host device 20 when the information processing device is offline. During the period from when the information processing device 1 logs on to the host device 20 until it logs off, the generator 5 updates the index information 10.

If a backed-up file A exists in the host device 20 in the case where the information processing device 1 is disconnected from the network 30, in spite of the fact that file A does not exist in the internal HDD 52, the file A is displayed in the folder that existed when it was backed up. At this time, file A is displayed on the screen in a display format that differs from those of other files in the internal HDD 52. For example, the icon for file A is displayed in black and white, or the extension of file A is replaced according to a predetermined display rule. Specifically, for example, the extension “*.jpg” of file A is replaced with “*.jpgoff” and displayed.

An operation at this time will be explained with reference to FIG. 4A and FIG. 4B. When the AP 50 reads file A (step M10), the command intercept processor (command controller) 3 detects the access to file A. Then, access to file A is then momentarily interrupted. From the file list a 9 stored in the file controller 6, it is confirmed that file A does not exist in the internal HDD 52 but is stored in the storage HDD 53 of the host device 20 (step M12). The display converter 4 displays the name of file A based on the display rules such as those stored in the display conversion list 8 (Update name of file A to AXXX: step M14). For example, if a rule to display the extension “*.jpg” as “*.jpgoff” is stored in the display conversion list 8, the display converter 4 displays “A.jpgoff” on the screen (part (e) of FIG. 4B). In this state, when the information processing device is connected to the host device 20 via the network 30 and logs on to the backup service, the display converter 4 displays “A.jpg” on the screen.

An applied example of the operation in FIG. 4B will be explained. When there is a file or holder that is newly added to the storage HDD 53 by the network service, and these are added to the file list 55b, based on a list update instruction (step M11), the file controller 6 also reflects them in a file list a 54 (Synchronous process: step M13). If the information processing device 1 is logged on, the newly added file or holder is displayed on the screen. Even if the information processing device 1 has logged off, the added file or holder can be identifiably displayed in compliance with a predetermined display rule. A display conversion list is set such that, for example, if the extension of the original file is “*.jpg”, “add” is added to that file extension to indicate that it is an added file. For example, when the display conversion list stores a rule to display the extension of the file as “*.jpgadd”, it is displayed on the screen as A.jpgadd (part (e) of FIG. 4B).

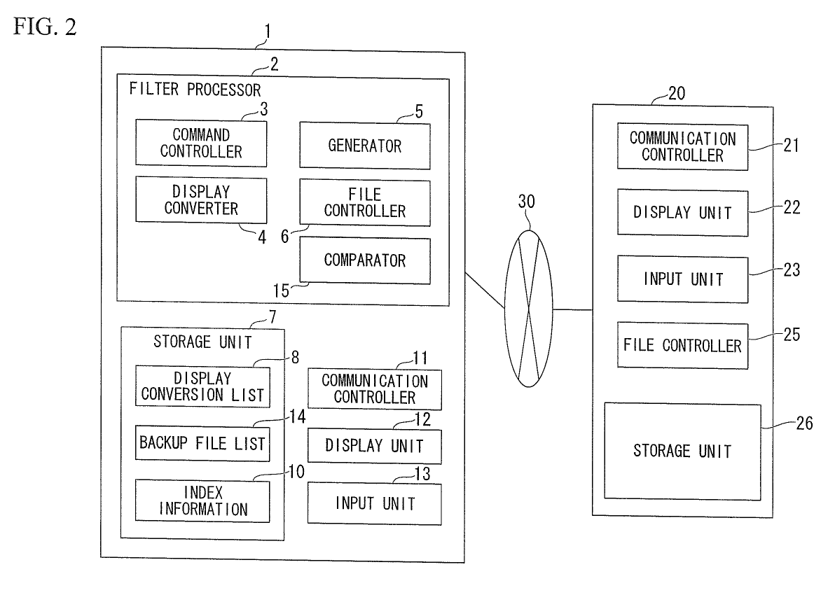

Subsequently, an information processing device 1 according to a second exemplary embodiment of the invention will be explained with reference to FIG. 2.

FIG. 2 is an explanatory block diagram showing the configuration of a system including an information processing device 1, a network 30, and a host device 20 according to this exemplary embodiment of the invention. Points of difference with the first exemplary embodiment will be explained.

In the system according to the second exemplary embodiment of the invention shown in FIG. 2, functions of the invention are carried out on the information processing device 1 side. The host device 20 of FIG. 2 is a conventional file server, and does not include the comparator 24 and the file list b 27.

A comparator 15 is added to the filter processor 2 of the information processing device 1 in FIG. 2. A backup file list 14 is added to the storage unit 7 of the information processing device 1 in FIG. 2, and the file list a 9 is deleted.

The file controller 6 can, as way of controlling files in the information processing device 1, read information relating to files stored in the storage unit 7 using an OS (operating system) file management function of the information processing device 1.

The backup file list 14 is a list of files that are backed-up to the host device 20 from the information processing device 1. The comparator 15 compares file information stored in the storage unit 7 read by the file controller 6 with file information in the backup file list 14, and extracts differential information.

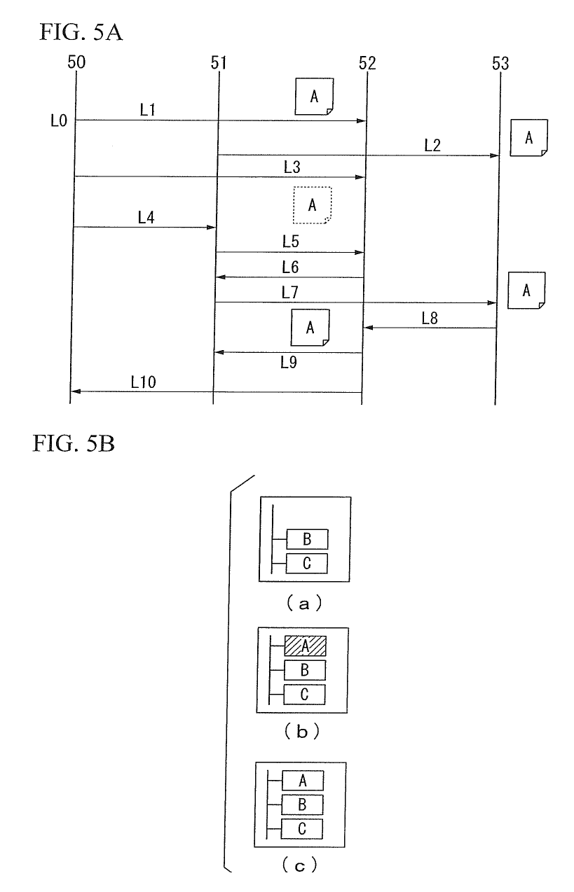

Subsequently, an operation of the information processing device 1 according to the second exemplary embodiment of the invention will be explained with reference to FIGS. 5A and 5B.

The AP 50 newly creates a file A (Newly create file A: step L0). This file A is then stored in the internal HDD 52 (Write file A: step L1). When file A stored in the internal HDD 52 is backed up to the storage HDD 53 which is the host device 20 (Back up file A: step L2), the file controller 6 stores file A in the backup file list 14. File A is deleted from the internal HDD 52 (Delete file A: step L3). Also, the AP 50 reads file A (Read file A: step L4). The virtual filter control 51 then uses an OS file management function to inquire whether file A is stored in the internal HDD 52 (Read file A: step L5). Since it becomes clear that file A is not stored in the internal HDD 52 in the step L5, a read error is generated (Read error: step L6). The comparator 15 provides information indicating that file A is not stored in the internal HDD 52, while the backup file list 14 indicates that file A is backed up in the storage HDD 53. The file controller 6 issues an instruction to rewrite file A to the internal HDD 52 (Instruction to rewrite file A: step L7), and file A is written from the storage HDD 53 back to the internal HDD 52 (Process of rewriting file A: step L8). This completes the process of rewriting file A to the internal HDD 52 (File A rewrite completion response: step L9), and file A is then read to the AP 50 (File A read response: step L10).

A system including the information processing device 1 and the host device 20 shown in FIGS. 1 and 2 can be realized by special-purpose hardware, or it can be configured by a general-purpose computer system such as a personal computer, and respective functions of the system shown in FIGS. 1 and 2 can then be realized by executing a program for that purpose.

A program for realizing the system functions shown in FIGS. 1 and 2 can be stored in a computer-readable recording medium, and can be executed by making a computer system read the program stored in the recording medium. Here, ‘computer system’ includes hardware such as peripheral devices and an OS.

If a www system is used, ‘computer system’ also includes an environment for providing (or displaying) websites.

‘Computer-readable recording medium’ includes writable non-volatile memories such as a flexible disk, a magneto-optical disk, a ROM, a flash memory, portable media such as a CD-ROM, and storage devices such as hardware in a computer system.

‘Computer-readable recording medium’ includes those that hold a program for a fixed time, such as a volatile memory (e.g. a dynamic random access memory {DRAM} etc.) in computer systems that become servers and clients when a program is transmitted via a communication line such as a telephone line or a network such as the Internet.

The program can be transmitted from a computer system where it was stored in a storage device to another computer system via a transmission medium, or by transmission waves in a transmission medium. Here, a ‘transmission medium’ for transmitting the program denotes a medium having a function of transmitting information such as a network (communication network) such as the Internet and a communication wire (communication line) such as a telephone line.

Further, it is acceptable for the program to realize some of the functions described above. The functions can also be realized in combination with a program already stored in the computer system, in what is known as a differential file (differential program).

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A file control system comprising a host device and an information processing device that is connectable to the host device via a network,
the host device comprising:
a comparator that compares first file information stored in a first storage unit of the information processing device with second file information stored in a second storage unit of the host device, and extracts differential information; and
a transmitter that transmits the differential information to the information processing device, and
the information processing device comprising:
a receiver that receives the differential information; and
a generator that generates index information on a file that is stored in the second storage unit and not stored in the first storage unit based on the received differential information.

2. The file control system according to claim 1, wherein the information processing device further comprises a display unit that displays file information in the index information in association with the first storage unit.

3. The file control system according to claim 2, wherein the information processing device further comprises a display converter that converts a display format of the file information which is displayed in association with the first storage unit and is based on the index information into a first display format that is the same as a display format of the first file information when the information processing device is logged on to the host device, and that converts the display format of the file information to a second display format that differs from the first display format when the information processing device is logged off from the host device.

4. The file control system according to claim 3, wherein a display color of a file or attribute of a file in the first display format is the same as that in a display format of the first file information, and a display color of a file or attribute of a file in the second display format differs from that in the display format of first file information.

5. An information processing device that constitutes a file control system comprising a host device and the information processing device that is connectable to the host device via a network,
the host device comprising:
a comparator that compares first file information stored in a first storage unit of the information processing device with second file information stored in a second storage unit of the host device, and extracts differential information; and
a transmitter that transmits the differential information to the information processing device, and
the information processing device comprising:
a receiver that receives the differential information; and
a generator that generates index information on a file that is stored in the second storage unit and not stored in the first storage unit based on the received differential information.

6. The information processing device according to claim 5 further comprising a display unit that displays file information in the index information in association with the first storage unit.

7. An information processing device that constitutes a file control system comprising a host device and the information processing device that is connectable to the host device via a network,
the host device comprising:
a first storage unit that stores a file from the information processing device; and
a transmitter that sends the file to the information processing device, and
the information processing device comprising:
a second storage unit;
a list of information on a file transmitted from the information processing device to the host device, the list being stored in the second storage unit;
a file controller that reads file information stored in the second storage unit using an OS function of the information processing device;
a comparator that compares the list and the file information read from the file controller; and
a generator that generates index information on a file that is stored in the first storage unit and not stored in the second storage unit based on differential information obtained by the comparator.

8. The information processing device according to claim 7 further comprising a display unit that display file information based on the index information in association with the second storage unit.

9. A host device that constitutes a file control system comprising the host device and an information processing device that is connectable to the host device via a network,
the host device comprising
a comparator that compares first file information stored in a first storage unit of the information processing device with second file information stored in a second storage unit of the host device, and extracts differential information; and
a transmitter that transmits the differential information to the information processing device, and
the information processing device comprising
a receiver that receives the differential information; and
a generator that generates index information on a file that is stored in the second storage unit and not stored in the first storage unit based on the received differential information.

10. The host device according to claim 9, wherein the information processing device further comprises a display unit that displays file information based on the index information in association with the first storage unit.

11. A recording medium storing a computer program executed by an information processing device that constitutes a system comprising a host device and an information processing device that is connectable to the host device via a network, the program comprising:
comparing first file information stored in a first storage unit of the information processing device with second file information stored in a second storage unit of the host device, and extracting differential information;
transmitting the differential information to the information processing device;
receiving the differential information; and
generating index information on a file that is stored in the second storage unit and not stored in the first storage unit based on the received differential information,
comparing the first file information and transmitting the differential information being executed in the host device, and receiving the differential information and generating the index information being executed in the information processing device.

12. The recording medium according to claim 11, wherein the computer program further comprises displaying file information based on the index information in association with the first storage unit, and displaying the file information is executed in the processing device.

13. A recording medium storing a computer program executed by an information processing device that constitutes a system comprising a host device and the information processing device that is connectable to the host device via a network, the program comprising:
storing a file from the information processing device in a first storage unit of the host device;
sending the file to the information processing device;
storing a list of information on a file transmitted from the information processing device to the host device, the list being stored in a second storage unit of the information processing device;
using an OS function of the information processing device to read the file information stored in the second storage unit;
comparing the list and the file information read in using the OS function; and
generating index information on a file that is stored in the first storage unit and not stored in the second storage unit based on differential information obtained by the comparator,
storing the file and sending the file being executed in the host device, and storing the list, using the OS function, comparing the list and generating the index information being executed in the information processing device.

14. The recording medium according to claim 13, wherein the program further comprises displaying file information based on the index information in association with the second storage unit, and displaying the file information is executed in the information processing device.

15. An information processing device that constitutes a file control system comprising a host device and the information processing device that is connectable to the host device via a network,
the host device comprising:
a first storage unit that stores a file from the information processing device; and
a transmitter that sends the file stored in the first storage unit to the information processing device, and
the information processing device comprising:
a second storage unit;
a list of information on a file transmitted from the information processing device to the host device, the list being stored in the second storage unit;
a file controller that reads file information stored in the second storage unit using an OS function of the information processing device;
a comparator that compares the list and the file information read from the file controller;
a generator that generates index information on a file that is stored in the first storage unit and not stored in the second storage un it based on differential information obtained by the comparator; and
a file controller that adds information of the list to a list of the file information stored in the second storage unit to expand the list of the file information as a list of logical file information of the second storage unit.

16. An information processing device that constitutes a file control system comprising a host device and an information processing device that is connectable to the host device via a network,
the host device comprising:
a first storage unit that stores a file from the information processing device; and
a transmitter that sends the file to the information processing device, and
the information processing device comprising:
a second storage unit;
a list of file information transmitted from the information processing device to the host device, the list being stored in the second storage unit;
a file controller that reads file information stored in the second storage unit using an OS function of the information processing device;
a comparator that compares the list and the file information read from the file controller;
a generator that generates index information on a file that is stored in the first storage unit and not stored in the second storage unit based on differential information obtained from the comparator;
a display unit that displays file information based on the index information in association with the second storage unit; and
a display converter that, before a display format of the file information of the list is inputted to the file controller, converts the display format to a display format that differs from that of a file in the first storage unit.
